(19) United States
(12) Patent Application Publication
(10) Pub. No.: US 2014/0062791 A1
(43) Pub. Date: Mar. 6, 2014

(54) LOCALIZATION METHOD OF SOURCE OF UNKNOWN SIGNAL BASED ON TDOA METHOD

(71) Applicant: KOREA AEROSPACE RESEARCH INSTITUTE, (US)

(72) Inventors: Deok Won LIM, Daejeon (KR); Hee Won KANG, Daejeon (KR); Moon-Beom HEO, Daejeon (KR)

(21) Appl. No.: 13/857,958

(22) Filed: Apr. 5, 2013

(30) Foreign Application Priority Data
Sep. 3, 2012 (KR) 10-2012-0097273

(51) Int. Cl. G01S 1/20

(52) U.S. Cl. CPC G01S 1/20
USPC 342/387

(57) ABSTRACT

Disclosed is a localization method of a source of unknown signal based on a TDOA method, comprising a data obtaining step S100 of receiving and obtaining the unknown signal using multiple sensors; an objective function value calculating step S200 of finding a cross-correlation value, and calculating an objective function value; a reference sensor selecting step S300 of selecting a reference sensor for calculating a TDOA measurement value; a TDOA measurement value calculating step S400 of finding a time when a cross-correlation value Rᵣᵢ(τ) found by performing cross-correlation of signal received in each of the reference sensor selected and an i-th sensor with respect to a delay time τ becomes maximum; and a location estimating step S500 of localizing the source of unknown signal. Therefore, the present invention can precisely localize the source of the unknown signal.

### CROSS-REFERENCE(S) TO RELATED APPLICATIONS

The present invention claims priority of Korean Patent Application No. 10-2012-0097273, filed on Sep. 3, 2012, which is incorporated herein by reference.

### BACKGROUND OF THE INVENTION

1. Field of the Invention

The present invention relates to a localization method of a source of unknown signal based on a TDOA method, and more particularly to a localization method of a source of an unknown signal based on a TDOA method, which can precisely estimate the source of unknown signal using a TDOA method.

2. Description of Related Art

GPS (Global Positioning System) is a system for providing services time, position and velocity of an object using satellites. When providing the position of an object using the GPS, the position is estimated based on the GPS signals.

There have been proposed various localization methods of a source of unknown signal, which can be classified into a time-based localization method and an angle-based localization method. However, it is known that the time-based localization method is superior to the angle-based localization method.

Meanwhile, GPS satellites are located at an altitude of about 20,000 km so as to transmit signals to a receiver, and thus, the power of the GPS signals received on the ground is very weak. In order to receive such weak signal, a GPS receiver should have high sensitivity. As a result, since the GPS receiver also receives interference signal and/or even jamming signal generated from other signal source, it is very difficult or impossible to receive the wanted GPS signal and perform the localization. Therefore, in case that the interference signal and/or jamming signal (hereinafter, called “unknown signal”) are included in the GPS signal, availability of the GPS is extremely deteriorated.

Recently, damages from the unknown signal, such as aircraft navigation problems, have been sharply increased, and thus a method of reducing the damages from such unknown signal has been studied. Currently, a method of localizing a source of unknown signal, particularly using a time-based localization method, is being studied actively.

As examples of the time-based localization method, there are a TOA (Time Of Arrival) technique using a signal arrival time and a TDOA (Time Difference Of Arrival) technique using a time difference of signal arrival. In addition, there are also an AOA (Angle Of Arrival) technique using an arrival angle of signal, an RSSI (Received Signal Strength Indication) technique using a signal strength, or the like.

However, in case of the TOA technique which is usually used in a satellite navigation system, time synchronization between a transmitter and a receiver is required. In case of the RSSI technique, it has low accuracy. In case of the AOA technique, it is not sensitive to the time synchronization but requires antenna alignment among receiving sensors and has a lower localization performance than the TDOA technique. In case of the TDOA technique, since it does not require the time synchronization and it can be applied even when the input signal is not known, it has become a typical method of localizing the source of the unknown signal.

In the TDOA-based localization method which uses the time difference of signal arrival, the position of the signal source can be calculated by using a time difference of signal arrival between a reference sensor and other sensors (GPS receivers). Herein, as shown in FIG. 1a, the position of the signal source calculated by the time difference of signal arrival can be indicated in the form of a hyperbolic curve, and the position of the signal source can be estimated by finding an intersection point of the multiple hyperbolic curves.

Herein, the time difference of signal arrival between the two sensors can be calculated by using a cross-correlation function indicated by Equation 1. When the signals received in the two sensors are cross-correlated with each other, a cross-correlation value Rᵣᵢ(τ) forms a curve shown in FIG. 1b and has one maximum value. A delay time in the maximum value is the time difference of arrival τᵣᵢ, i.e., TDOA measurement value.

$${R}_{ri} ( τ ) = E [ {S}_{r} ( t ) {S}_{i} ( t - τ ) ] = \frac{1}{T} {\int }_{0}^{T} {S}_{r} ( t ) {S}_{i} ( t - τ ) d t , \\ 0 \leq τ \leq {T}_{max} \qquad [ Equation 1 ]$$

wherein Rᵣᵢ(τ) is a cross-correlation value between a reference sensor and an i-th sensor, Sᵣ(t) and Sᵢ(t) are each signal received in the reference sensor and an i-th sensor, T is an integration time, τ is a delay time, and Tₘₐₓ is a upper limit of a delay time.

In practice, because a process of finding the TDOA measurement value using the Equation 1 is implemented in a discrete time domain, the Equation 1 can be expressed into Equation 2 in the discrete time domain, as follows:

$${R}_{ri} ( m ) = \frac{1}{N} {\sum }_{n = 0}^{N - \vert m \vert - 1} {S}_{r} ( {nT}_{s} ) {S}_{i} ( {nT}_{s} + {mT}_{s} ) , 0 \leq m \leq {M}_{max} \qquad [ Equation 2 ]$$

wherein Rᵣᵢ(m) is a cross-correlation value, m is a discrete delay time, N is the number of samples, and Sᵣ(nTₛ) and Sᵢ(nTₛ) are each signal received in the reference sensor and the i-th sensor at each discrete time nTₛ, Mₘₐₓ is a upper limit of a discrete delay time. And a delay time mᵣᵢTₛ in which the cross-correlation value becomes maximal is the TDOA measurement value in discrete time domain.

In finding the TDOA measurement value using the Equation 2, if cross correlation is performed for the received signal in the state that the received signal is known, it is possible to estimate the true TDOA measurement value by using the cross correlation function of the known signal. However, in the state that the received signal is unknown, the TDOA measurement can be found by using the delay time in which the cross-correlation value Rᵣᵢ(m) becomes maximal. Therefore, in this case, the measurement performance is influenced by the sampling period and a maximum error of the TDOA measurement value is corresponding to a half of a sampling period. Furthermore, for a given sampling period, the measurement performance is changed according to which reference sensor is selected from the installed sensors.

### SUMMARY OF THE INVENTION

An embodiment of the present invention is directed to providing a localization method of a source of unknown signal, which can precisely localize the source of the unknown signal based on a TDOA method, thereby solving the problems of the conventional TDOA-based localization method.

To achieve the object of the present invention, the present invention provides a localization method of a source of unknown signal based on a TDOA method, including a data obtaining step of receiving and obtaining the unknown signal using multiple sensors; an objective function value calculating step of finding a cross-correlation values by performing cross-correlation of the signal obtained in the data obtaining step with respect to a discrete delay time, and then calculating an objective function value using the cross-correlation values; a reference sensor selecting step of selecting a reference sensor for calculating a TDOA measurement value; a TDOA measurement value calculating step of finding a delay time when a cross-correlation value found by performing cross-correlation for the reference sensor selected in the reference sensor selecting step and an i-th sensor with respect to a delay time becomes maximum; and a location estimating step of localizing the source of unknown signal using the TDOA measurement value calculated in the TDOA measurement value calculating step.

### BRIEF DESCRIPTION OF THE DRAWINGS

FIGS. 1a and 1b are concept view showing the principle of localizing a source of unknown signal.

FIG. 2 is a flow chart of a localization method of a source of unknown signal based on a TDOA method according to the present invention.

FIG. 3 is a flow chart showing the logical structure of the localization method of the source of the unknown signal based on the TDOA method according to the present invention.

FIG. 4 is a graph of a horizontal error in a conventional TDOA method.

FIG. 5 is a graph of a horizontal error in a TDOA method according to the present invention.

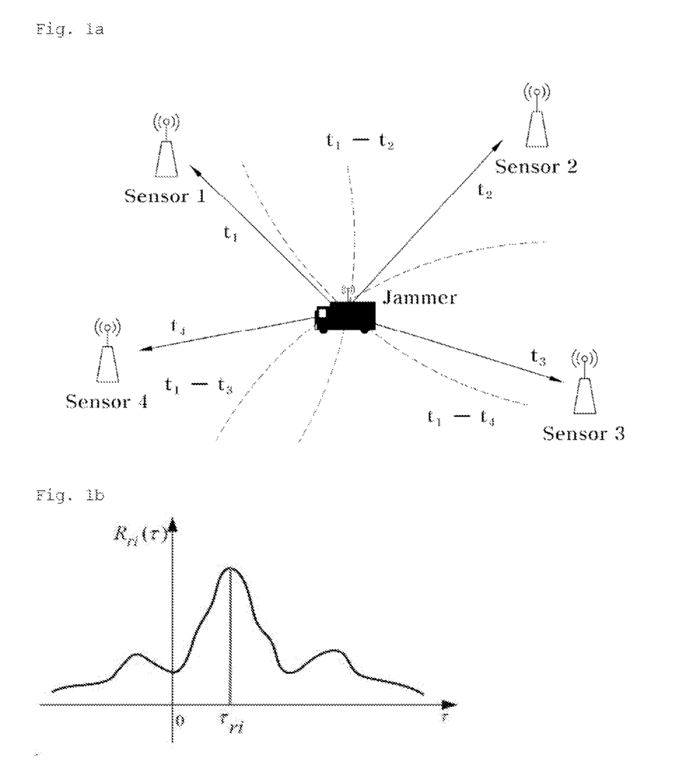

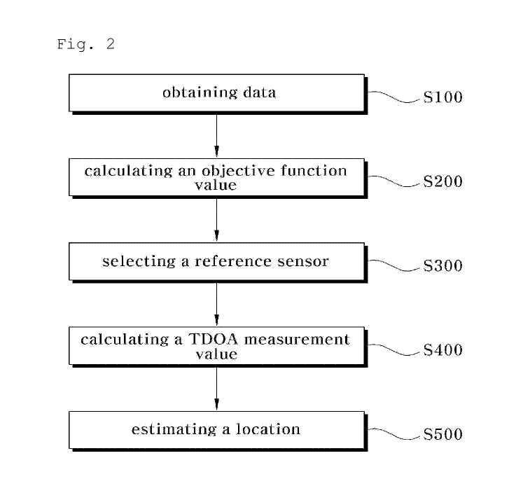

### DESCRIPTION OF SPECIFIC EMBODIMENTS

Hereinafter, the embodiments of the present invention will be described in detail with reference to accompanying drawings.

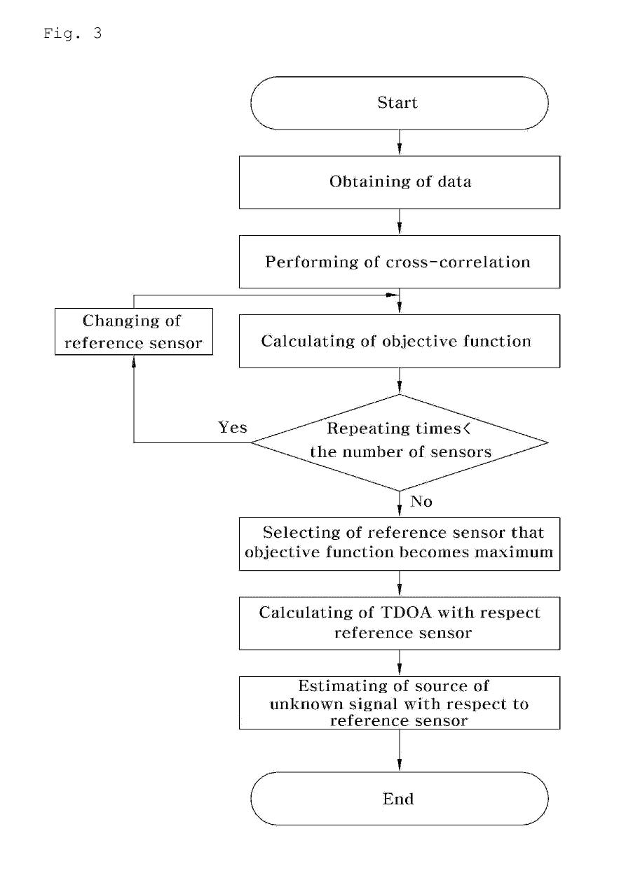

The present invention is to provide a localization method of a source of unknown signal using a TDOA method. To this end, as shown in FIGS. 2 and 3, the present invention includes a step S100 of obtaining data, a step S200 of calculating an objective function value, a step S300 of selecting a reference sensor, a step S400 of calculating a TDOA measurement value, and a step S500 of estimating a location.

(1) Step S100 of Obtaining Data

In the step S100 of obtaining data, unknown signal is received and obtained by using multiple (N) GPS receivers (sensors).

The GPS receiver functions to receive GPS signal generated from a navigation satellite or the like. The GPS signal is a previously known signal. However, unknown signal as well as the known GPS signal, i.e., the GPS signal (Sᵣ(t) and Sᵢ(t) in the above-mentioned Equation 1) may be included in the signal received by the GPS receiver (sensor), and thus the step S100 is to receive and obtain the unknown signal if the unknown signal is included in the signal received by the GPS receiver (sensor).

(2) Step S200 of Calculating Objective Function Value

In the step S200 of calculating an objective function value at a computer of the central tracking system, the cross-correlation is performed with respect to the unknown signal obtained in the step S100 in order to find a cross-correlation value Rᵣᵢ(m). Then, the objective function value is calculated by using the cross-correlation value Rᵣᵢ(m).

If the cross-correlation is performed with respect to the known signal by applying the Equation 2, a TDOA measurement value can be estimated by using the cross correlation function of the known signal. However, in case that the unknown signal is included in the received signal, it is difficult to estimate the true TDOA measurement. Therefore, the TDOA measurement can be only found by using the delay samples mᵣᵢ in which the cross-correlation value Rᵣᵢ(m) becomes maximal. Furthermore, for a given sampling period, the measurement performance is changed according to which reference sensor is selected from the installed sensors.

Therefore, according to the present invention, the objective function ratio(r) is defined by Equation 3 to be described below, and the objective function value is calculated by using the defined objective function ratio(r), while the sensor is changed in turn. Then, the reference sensor that the calculated objective function value becomes maximal is set as a reference sensor for calculating the TDOA measurement value.

$$ratio ( r ) = {\sum }_{i = 1 i \neq r}^{N} \frac{{R}_{ri} ( {m}_{ri} )}{{R}_{ri} ( {m}_{ri} - 1 ) + {R}_{ri} ( {m}_{ri} + 1 )} \qquad [ Equation 3 ]$$

wherein ratio(r) is the objective function, Rᵣᵢ(□) is a cross-correlation value with respect to the signal received in each of the reference sensor and the i-th sensor, and mᵣᵢ is a delay samples that the cross-correlation value Rᵣᵢ(□) becomes maximal, and N is the number of the sensors.

Herein, the cross-correlation value is changed according to the reference sensor selected from the N sensors. Therefore, in the present invention, the cross-correlation value of the signals received in the reference sensor and the i-th sensor is found, while the reference sensor is changed in turn, and then a ratio of the cross-correlation value with respect to the sum of the former and latter cross-correlation values, i.e., the objective function value defined by the Equation 3 is calculated. As described above, the measurement performance is influenced by the sampling period. And for a given sampling period, the measurement performance is changed according to which reference sensor is selected from the installed sensors. Herein, the operation complexity of the objective function is increased by the number of the sensors.

(3) Step S300 of Selecting Reference Sensor

In the step S300 of selecting a reference sensor, the reference sensor that the one among the objective function values calculated from the step S200 becomes maximal is selected as the reference sensor for calculating the TDOA measurement value at the computer of the central tracking system.

As described above, since the measurement performance is changed according to the selected reference sensor, the objective function value is calculated by using the Equation 3 while the reference sensor is changed in turn, and then the reference sensor that the objective function value becomes maximal is selected as the reference sensor for calculating the TDOA measurement value.

In case that the objective function value is calculated by the step S200, the objective function value in an ideal environment has a minimum value of 1 and a maximum value of infinity.

(4) Step S400 of Calculating TDOA Measurement Value

In the step S400 of calculating a TDOA measurement value, a TDOA measurement value, i.e., a time when a cross-correlation value Rᵣᵢ(τ) found by performing the cross-correlation with respect to the signal received in each of the reference sensor and the i-th sensor becomes maximum (peak) is calculated.

(5) Step S500 of Estimating Location

In the step S500 of estimating a location, if the TDOA measurement value τᵣᵢ is calculated by the step S400, the source of the unknown signal is estimated by using the TDOA measurement value τᵣᵢ at the computer of the central tracking system.

A time difference of arrival between the reference sensor and the i-th sensor is the TDOA measurement value. Herein, the time difference of arrival is corresponding to a location difference with respect to a speed c of the signal, and thus the TDOA measurement value τᵣᵢ can be expressed by a function with respect to the locations of the two sensors and the source of the unknown signal, which is the Equation 4, as follows:

$$\begin{matrix}{τ}_{ri} = ( {t}_{r} - {t}_{s} ) - ( {t}_{i} - {t}_{s} ) \\ = \frac{\sqrt{{( x - {x}_{r} )}^{2} + {( y - {y}_{r} )}^{2}} - \sqrt{{( x - {x}_{i} )}^{2} + {( y - {y}_{i} )}^{2}}}{c} \\ = {f}_{ri} ( x , y , {x}_{r} , {y}_{r} , {x}_{i} , {y}_{i} )\end{matrix} \qquad [ Equation 4 ]$$

wherein tₛ is a time when the unknown signal is transmitted, tᵣ is a time when the reference sensor receives the unknown signal, tᵢ is a time when the i-th sensor receives the unknown signal, (x,y) is a location coordinate of the source of the unknown signal, (xᵣ,yᵣ) is a location coordinate of the reference sensor, and c is a speed of the signal.

If the TDOA measurement value is found, the location (x,y) of the source of the unknown signal can be calculated by using the Equation 4. However, because the Equation 4 is a nonlinear equation, it is difficult to directly calculate the location (x,y). Therefore, if the Taylor series is applied to the Equation 4, the Equation 4 can be linearized into Equation 5, as follows:

$${τ}_{ri} = {f}_{ri} ( □ ) ≅ {f}_{ri} ( □ ) {\vert}_{( {x}_{0} , {y}_{0} )} + \frac{\partial {f}_{r , i} ( □ ) {\vert}_{( {x}_{0} , {y}_{0} )}}{\partial {x}_{0}} δ x + \frac{\partial {f}_{r , i} ( □ ) {\vert}_{( {x}_{0} , {y}_{0} )}}{\partial {y}_{0}} δ y = \frac{1}{c} ( \sqrt{{( {x}_{0} - {x}_{r} )}^{2} + {( {y}_{0} - {y}_{r} )}^{2}} - \sqrt{{( {x}_{0} - {x}_{i} )}^{2} + {( {y}_{0} - {y}_{i} )}^{2}} ) + \frac{1}{c} ( \frac{{x}_{0} - {x}_{i}}{{( {x}_{0} - {x}_{i} )}^{2}} - \frac{{x}_{0} - {x}_{r}}{{( {x}_{0} - {x}_{r} )}^{2} + {( {y}_{0} - {y}_{r} )}^{2}} ) δ x + \frac{1}{c} ( \frac{{y}_{0} - {y}_{i}}{{( {x}_{0} - {x}_{i} )}^{2} + {( {y}_{0} - {y}_{i} )}^{2}} - \frac{{y}_{0} - {y}_{r}}{{( {x}_{0} - {x}_{r} )}^{2} + {( {y}_{0} - {y}_{r} )}^{2}} ) δ y \qquad [ Equation 5 ]$$

wherein (x₀,y₀) is an initial location coordinate of the source of the unknown signal.

Assuming that there are N sensors, a first sensor is a reference sensor and the rest second to N-th sensors are i-th sensors, the Equation 5 can be expressed by Equation 6 which is a matrix, as follows:

$$\frac{1}{c} [ \begin{matrix}{G}_{x 21} & {G}_{y 21} \\ {G}_{x 31} & {G}_{y 31} \\ ⋮ & ⋮ \\ {G}_{xN 1} & {G}_{yN 1}\end{matrix} ] [ \begin{matrix}δ x \\ δ y\end{matrix} ] = [ \begin{matrix}{τ}_{12} - {τ}_{12} {\vert}_{( {x}_{0} , {y}_{0} )} \\ {τ}_{13} - {τ}_{13} {\vert}_{( {x}_{0} , {y}_{0} )} \\ ⋮ \\ {τ}_{1 N} - {τ}_{1 N} {\vert}_{( {x}_{0} , {y}_{0} )}\end{matrix} ] ⇒ G δ = Z \\ wherein \\ {G}_{xi 1} is \frac{{x}_{0} - {x}_{i}}{{( {x}_{0} - {x}_{i} )}^{2} + {( {y}_{0} - {y}_{i} )}^{2}} - \frac{{x}_{0} - {x}_{1}}{{( {x}_{0} - {x}_{1} )}^{2} + {( {y}_{0} - {y}_{1} )}^{2}} , \\ {G}_{yi 1} is \frac{{x}_{0} - {x}_{i}}{{( {x}_{0} - {x}_{i} )}^{2} + {( {y}_{0} - {y}_{i} )}^{2}} - \frac{{x}_{0} - {x}_{1}}{{( {x}_{0} - {x}_{1} )}^{2} + {( {y}_{0} - {y}_{1} )}^{2}} , \\ {τ}_{1 i} {\vert}_{( {x}_{0} , {y}_{0} )} is [ \begin{matrix}\sqrt{{( {x}_{0} - {x}_{r} )}^{2} + {( {y}_{0} - {y}_{r} )}^{2}} - \\ \sqrt{{( {x}_{0} - {x}_{i} )}^{2} + {( {y}_{0} - {y}_{i} )}^{2}}\end{matrix} ] / c , \qquad [ Equation 6 ]$$

δ is a location variation, and Z is a residual (a difference between a measurement value and an estimation value).

In the Equation 6, since it is difficult to directly find the location variation δ, an estimation value of the location variation is used. To this end, the present invention uses Equation 7 which was proposed in “Position-location solution by Taylor-series Estimation” (IEEE Transaction on Aerospace and Electronic Systems, vol. AES-12, no. 2, pp. 187-194, March, 1976) by W. H. Foy, as follows:

\hat{δ}=[G^{T}Q⁻¹G]⁻¹G^{T}Q⁻¹Z, [Equation 7]

wherein Q is a covariance matrix of a measurement error.

Therefore, as shown in Equation 8 as follows, an estimation location coordinate (\hat{x},ŷ) can be found by adding the initial location (x₀,y₀) and the location variation \hat{δ} estimated by the Equation 7.

$$[ \begin{matrix}\hat{x} \\ \hat{y}\end{matrix} ] = [ \begin{matrix}{x}_{0} \\ {y}_{0}\end{matrix} ] + [ \begin{matrix}δ \hat{x} \\ δ \hat{z}\end{matrix} ] \qquad [ Equation 8 ]$$

As shown in the Equation 8, the estimation location (\hat{x},ŷ) of the source of the unknown signal is largely influenced by the initial location (x₀,y₀). Thus, the final estimation location (\hat{x},ŷ) of the source of the unknown signal is not found by only a single calculation process. Instead, the estimation location (\hat{x},ŷ) found by the Equation 8 is substituted again to the initial location (x₀,y₀), and then the process from the Equation 5 to the Equation 8 is repeated, thereby finding the estimation location (\hat{x},ŷ). This process is repeated until satisfying a stop condition. For example, the stop condition may be a case that the location variation \hat{δ} is less than a predetermined threshold value TH.

In order to confirm the usefulness of the localization method of the source of the unknown signal based on the TDOA method according to the present invention, the inventors simulated it. Hereinafter, it will be described.

The simulation was a MATLAB-based Monte-Carlo simulation which was performed 50 times, and transmission power was 5 mW, and the sensors were installed at edge portions of a square four kilometers on a side.

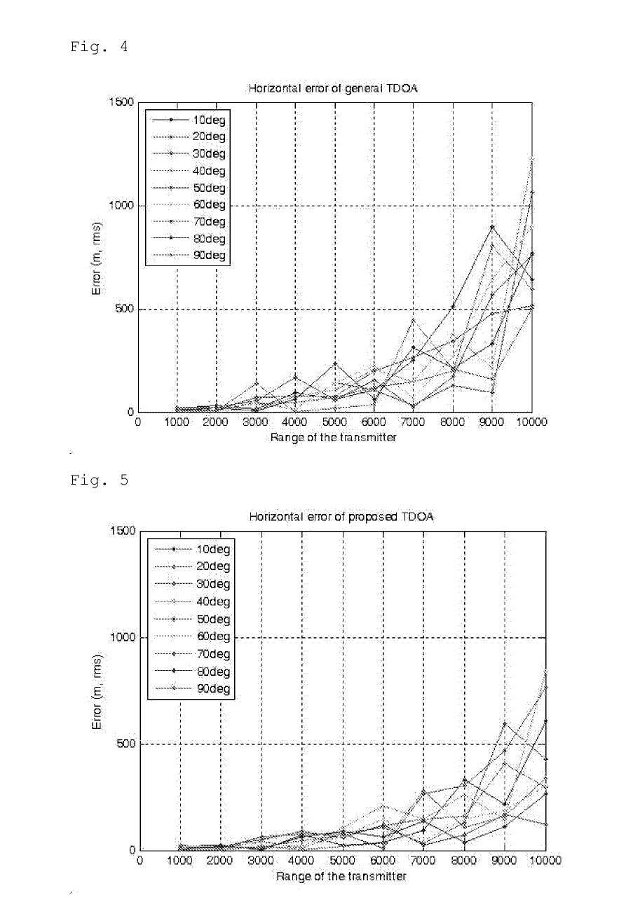

FIG. 4 is a graph showing a horizontal error of the location of the source of the unknown signal, which is estimated by a conventional TDOA method in case that a sampling frequency is 6 MHz. As shown in the graph, the error is sharply increased from a location that the source of the unknown signal is farther away than an installation distance (4 km) between the sensors, and a deviation according to an azimuth angle is also seen in large value. It is estimated that the reason why the error is increased according to the distance is that DOP (Dilution of Precision) becomes large, and the reason why the deviation according to the azimuth angle is seen in large value is that the reference sensor is selected randomly in the conventional method.

FIG. 5 is a graph showing a horizontal error of the location of the source of the unknown signal, which is found by using the localization method of the source of the unknown signal according to the present invention. When compared to the graph of FIG. 4, it can be understood that the localization method of the source of the unknown signal according to the present invention measure more precisely the location of the source of the unknown signal than the conventional method.

As described above, in the present invention, the sensor that the objective function value becomes maximal is selected as the reference sensor out of the multiple sensors, and then the source of the unknown signal is localized by using the selected reference sensor. Therefore, the localization method of the present invention can localize more precisely than the conventional method.

While the present invention has been described with respect to the specific embodiments, it will be apparent to those skilled in the art that various changes and modifications may be made without departing from the spirit and scope of the invention as defined in the following claims.

What is claimed is:

1. A localization method of a source of unknown signal at a computer of the central tracking system based on a TDOA method, comprising:
a data obtaining step S100 of receiving and obtaining the unknown signal using multiple sensors;
an objective function value calculating step S200 of finding a cross-correlation value Rᵣᵢ(m) by performing cross-correlation of the signal obtained in the data obtaining step S100 with respect to a discrete delay samples m, and then calculating an objective function value using the cross-correlation value Rᵣᵢ(m);
a reference sensor selecting step S300 of selecting a reference sensor for calculating a TDOA measurement value;
a TDOA measurement value calculating step S400 of finding a time when a cross-correlation value Rᵣᵢ(τ) found by performing cross-correlation of signal received in each of the reference sensor selected in the reference sensor selecting step S300 and an i-th sensor with respect to a delay time τ becomes maximum; and
a location estimating step S500 of localizing the source of unknown signal using the TDOA measurement value τᵣᵢ calculated in the TDOA measurement value calculating step S400.

2. The localization method according to claim 1, wherein the objective function value in the TDOA measurement value calculating step S400 is calculated by Equation 3, as follows:
$$ratio ( r ) = {\sum }_{i = 1 i \neq r}^{N} \frac{{R}_{ri} ( {m}_{ri} )}{{R}_{ri} ( {m}_{ri} - 1 ) + {R}_{ri} ( {m}_{ri} + 1 )} \qquad [ Equation 3 ]$$
wherein ratio(r) is the objective function, Rᵣᵢ(□) is a cross-correlation value with respect to the signal received in each of the reference sensor and the i-th sensor, and mᵣᵢ is a delay samples that the cross-correlation value Rᵣᵢ(□) becomes maximum, and N is the number of the sensors.

3. The localization method according to claim 2, wherein the reference sensor selected in the reference sensor selecting step S300 is a sensor that the objective function value calculated in the objective function value calculating step S200 becomes maximum.
